(19) United States
(12) Patent Application Publication
(10) Pub. No.: US 2026/0222496 A1
(43) Pub. Date: Jul. 30, 2026

(54) INSPECTION SYSTEM, INSPECTION APPARATUS, METHOD OF CONTROLLING THEM AND STORAGE MEDIUM

(71) Applicant: CANON KABUSHIKI KAISHA, Tokyo (JP)

(72) Inventor: Yukiyoshi HIKICHI, Tokyo (JP)

(21) Appl. No.: 19/449,788

(22) Filed: Jan. 15, 2026

(30) Foreign Application Priority Data
Jan. 24, 2025 (JP) 2025-010640

(51) Int. Cl. H04N 1/00

(52) U.S. Cl. CPC H04N 1/00005; H04N 1/00029; H04N 1/00079; H04N 1/00087; H04N 1/0009

(57) ABSTRACT

An inspection system comprising an image forming apparatus, an inspection apparatus that inspects a printed matter formed by the image forming apparatus. The inspection system reads the printed matter to generate an inspection target image, sets an inspection condition, compares the inspection target image with a reference image and generates an inspection result of the inspection target image based on the inspection condition. The inspection system causes a display to display the inspection result, and executes a confirmation mode that is able to change an inspection level included in the inspection condition and that causes a user to confirm an inspection result of the inspection target image corresponding to the changed inspection level.

### BACKGROUND

### Field of the Technology

The present disclosure relates to an inspection system, an inspection apparatus, a method of controlling them, and a storage medium.

### Description of the Related Art

There is a known inspection system that reads a sheet on which an image is printed by a printer with a scanner or a camera disposed at a subsequent stage of the printer, and compares the read image with a reference image registered in advance to inspect defectiveness of a printed matter.

Japanese Patent Laid-Open No. 2024-125018 makes it possible to display, on a screen, provisional inspection results at a plurality of candidate inspection levels different from an inspection level designated in the inspection in a case of determining a printing defect in inspection. It describes a technique that enables a user to reset the inspection level when the printing defect is determined.

However, the technique described in Japanese Patent Laid-Open No. 2024-125018 executes the inspection at a certain inspection level, and, unless the inspection fails, cannot confirm an inspection result at an alternative inspection level. Therefore, in order to determine whether the set inspection level is appropriate, it is necessary to repeat inspection and printing at mutually different inspection levels. If the inspection level is too high, a portion that is originally not desired to be detected as contamination may be detected as an image defect, or over detection such as detection as an image defect may be caused by a slight color difference. However, it is desirable to reliably detect contamination and the like at the time of printing by setting the inspection level as high as possible, and for this purpose, it is necessary to find an optimum inspection level. However, it is difficult to easily confirm how the inspection result changes at each inspection level before the inspection.

### SUMMARY

Embodiments of the present disclosure eliminate the above-mentioned issues with conventional technology.

A feature of embodiments of the present disclosure is to provide a technique that can easily confirm an appropriate inspection level in inspection for performing defectiveness determination of a printed matter.

According to embodiments of the present disclosure, there is provided an inspection system comprising: an image forming apparatus; an inspection apparatus that inspects a printed matter formed by the image forming apparatus; and one or more controllers including one or more processors and one or more memories, wherein the one or more controllers configured to: read the printed matter to generate an inspection target image; set an inspection condition; compare the inspection target image with a reference image and generate an inspection result of the inspection target image based on the inspection condition; cause a display to display the inspection result; and execute a confirmation mode that is able to change an inspection level included in the inspection condition and that causes a user to confirm an inspection result of the inspection target image corresponding to the changed inspection level.

Further features of the various embodiments will become apparent from the following description of exemplary embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 depicts a view illustrating a configuration example of an inspection system according to an embodiment of the present disclosure.

FIG. 2 is a block diagram for describing a hardware configuration of each apparatus in the inspection system according to the embodiment.

FIG. 3 depicts a schematic cross-sectional view for describing an internal configuration of a printing apparatus according to an embodiment and equipment to be connected to the printing apparatus.

FIG. 4 depicts a view illustrating an example of a property screen of a job to be displayed on a display unit of an information processing apparatus according to the embodiment.

FIG. 5 depicts a view illustrating an example of a setting screen of a job to be displayed on the display unit of the information processing apparatus according to the embodiment.

FIG. 6 is a functional block diagram for describing functions of the inspection apparatus according to the embodiment.

FIG. 7 depicts a view illustrating an example of a main screen of an inspection tool to be displayed on the display unit of the inspection apparatus according to the embodiment.

FIG. 8 depicts a view illustrating an example of a reference image creation screen to be displayed on the display unit of the inspection apparatus according to the embodiment.

FIG. 9 depicts a view illustrating an example of an inspection setting screen to be displayed when an edit button of FIG. 7 is pressed in the inspection apparatus according to the embodiment.

FIG. 10 depicts is a view illustrating an example of an inspection screen to be displayed on the display unit of the inspection apparatus according to the embodiment.

FIG. 11 depicts a view illustrating an example of an operation setting screen to be displayed on the inspection apparatus when an operation setting button is pressed on the screen of FIG. 9.

FIG. 12 depicts a view illustrating an example of a level check mode screen to be displayed on the display unit of the inspection apparatus according to the embodiment.

FIG. 13 depicts a view illustrating an example of an operation screen in a level check mode to be displayed on the display unit of the inspection apparatus according to the embodiment.

FIG. 14 depicts a view illustrating an example of an operation screen in a level check mode when the inspection level in an emphasized inspection area is changed from level 8 to level 7 and reinspection is performed.

FIG. 15 is a flowchart for describing processing when the inspection apparatus according to the embodiment executes the level check mode.

FIG. 16 is a flowchart for describing processing in which the inspection apparatus according to the embodiment executes reinspection at the changed inspection level to display the result thereof after the inspection level is changed.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

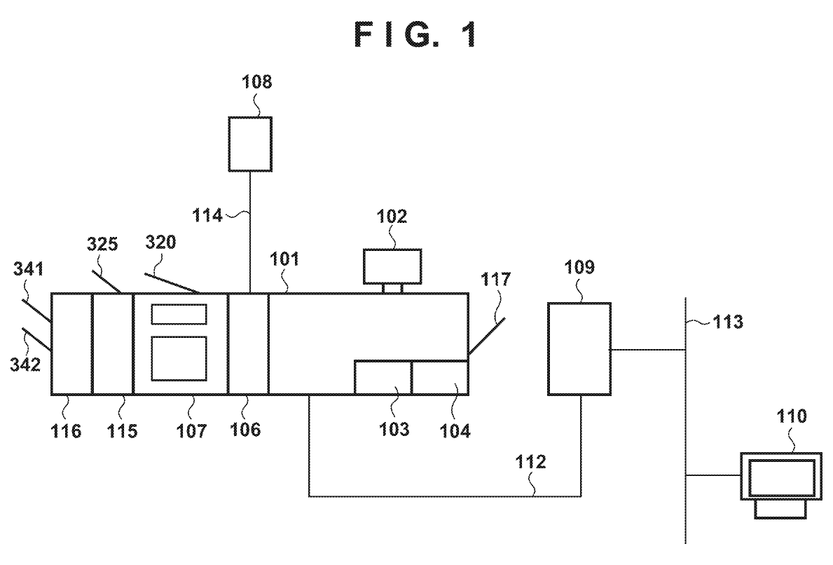

FIG. 1 depicts a view illustrating a configuration example of the inspection system according to the embodiment of the present disclosure. This inspection system includes an information processing apparatus 109, an inspection apparatus 108, a client computer 110, and a printing apparatus 101. Note that the printing apparatus according to the embodiment will be described with an example of printing apparatus of an electrophotographic type, but this printing apparatus may be a printing apparatus of a different image forming method such as an inkjet type or an offset printing type.

The printing apparatus 101 is connected to the information processing apparatus 109 via a cable 112. The information processing apparatus 109 is connected to the client computer 110 via a network 113.

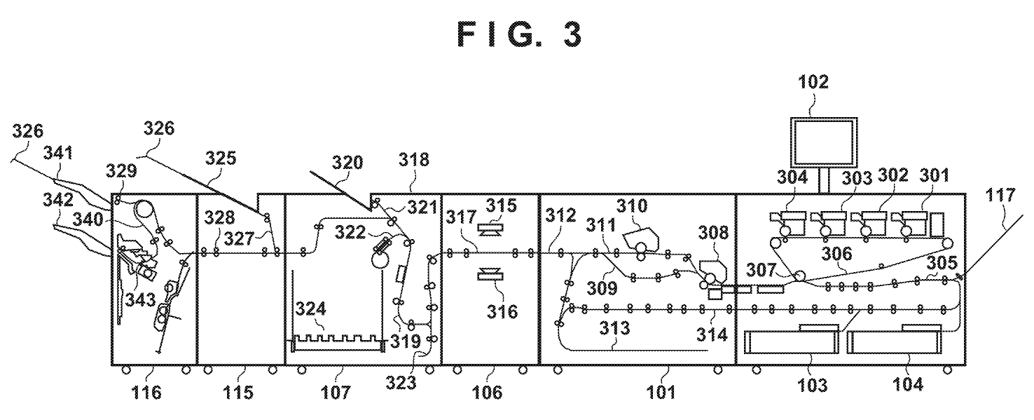

The printing apparatus 101 includes a user interface (UI) panel 102, a sheet feed deck 103, a sheet feed deck 104, and a manual feed tray 117. The UI panel 102 is a user interface including, for example, a capacitative touch panel. Furthermore, the printing apparatus 101 connects an inspection unit 106, a large-volume stacker 107, a relay conveyance unit 115, and a finisher 116 as optional accessories. The inspection unit 106 is connected to an inspection apparatus 108 via a cable 114. The large-volume stacker 107 has a main body 318 including a main tray 324 (FIG. 3) and a top tray 320, and thousands of sheets can be stacked on the main tray 324 at a time. The relay conveyance unit 115 also includes a top tray 325 that has sheet cooling and decurler functions and can stack printed sheets thereon. The finisher 116 has a finishing processing function such as stapling, and includes trays 341 and 342 for stacking sheets subjected to finishing processing.

A print job is generated by the client computer 110, transmitted to the information processing apparatus 109 via the network 113, and managed by the information processing apparatus 109. Then, the print job is transmitted from the information processing apparatus 109 to the printing apparatus 101 through the cable 112, and the printing apparatus 101 performs processing of printing on a sheet. The information processing apparatus 109 is, for example, a print controller. Note that the print job may take a form in which it is generated and managed by the information processing apparatus 109, transmitted to the printing apparatus 101 via the network 113, and managed by the printing apparatus 101.

The client computer 110, the information processing apparatus 109, and the inspection apparatus 108 may take a form in which they are connected to the cable 112 to be communicable with the printing apparatus 101. The inspection apparatus 108 may also take a form in which it is connected to the information processing apparatus 109 and the client computer 110 via the network 113. That is, the connection form of the printing apparatus 101, the information processing apparatus 109, and the client computer 110 illustrated in FIG. 1 is an example, and it goes without saying that there are various connection forms other than those illustrated in the present embodiment. The printing apparatus 101 may also take a form in which a folding device, a book binding device, and the like other than the above-described equipment are connected.

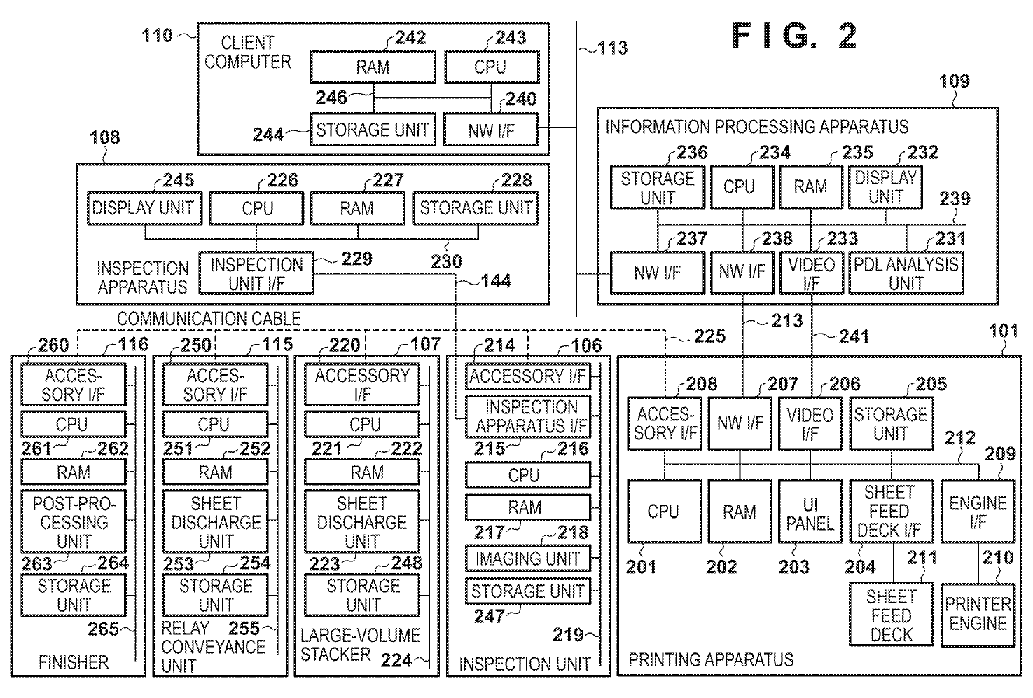

FIG. 2 is a block diagram for describing the hardware configuration of each apparatus in the inspection system according to the embodiment.

First, the configuration of the printing apparatus 101 will be described.

By deploying, into a random access memory (RAM) 202, a program stored in a storage unit 205 to execute it, a central processing unit (CPU) 201 manages control and calculation in each unit in the printing apparatus 101 via a system bus 212. The RAM 202 is a type of general volatile storage device that can be directly accessed from the CPU 201, and is used as a work area of the CPU 201 and other temporary data storage areas. The storage unit 205 functions as a temporary storage area and a work memory during operation of the printing apparatus 101.

An engine interface (I/F) 209 manages communication with and control of a printer engine 210. A sheet feed deck I/F 204 manages communication with and control of a sheet feed deck 211. The sheet feed deck 211 collectively refers to the sheet feed decks 103 and 104 of FIG. 1 as a hardware configuration. A UI panel 203 is a hardware configuration of the UI panel 102 of FIG. 1, and provides a user interface for performing the overall operation of the printing apparatus 101. In the embodiment, the UI panel 203 is assumed to include a capacitative touch panel.

A network interface (NWI/F) 207 is connected to an NWI/F 238 of the information processing apparatus 109 via a cable 213, and manages communication between the information processing apparatus 109 and the printing apparatus 101. Note that the embodiment assumes a form in which the network interfaces connected to the system bus 212 and a system bus 239 are directly connected to each other, but the information processing apparatus 109 and the printing apparatus 101 may take a form in which they are connected to each other by, for example, a network or the like, and the connection form thereof is not limited. A video I/F 206 is connected to a video I/F 233 via a video cable 241, and manages communication of image data between the information processing apparatus 109 and the printing apparatus 101. Note that the cable 112 of FIG. 1 may include the cable 213 and the video cable 241.

Note that the connection interface with the printing apparatus 101 in the information processing apparatus 109 may integrate the functions of the NWI/F 238 and the video I/F 233. The connection interface with the information processing apparatus 109 in the printing apparatus 101 may integrate the functions of the NWI/F 207 and the video I/F 206.

An accessory I/F 208 is connected to a plurality of accessory I/Fs 214, 220, 250, and 260 via a cable 225. That is, the printing apparatus 101 communicates with the inspection unit 106, the large-volume stacker 107, the relay conveyance unit 115, and the finisher 116 via these accessory I/Fs.

Next, a configuration of the inspection unit 106 will be described.

By deploying, into a RAM 217, a program stored in a storage unit 247 to execute it, a CPU 216 manages control and calculation in each unit in the inspection unit 106 via a system bus 219. The RAM 217 is a type of general volatile storage device that can be directly accessed from the CPU 216, and is used as a work area of the CPU 216 and other temporary data storage areas. The storage unit 247 stores a program to be executed by the CPU 216, and further functions as a temporary storage area and a work memory during operation of the inspection unit 106. An inspection apparatus I/F 215 is connected to an inspection unit I/F 229 of the inspection apparatus 108 via a cable 144. That is, the inspection unit 106 communicates with the inspection apparatus 108 via the inspection apparatus I/F 215 and the inspection unit I/F 229.

An imaging unit 218 includes an imaging function equipped with, for example, a contact image sensor (hereinafter, CIS), caputures a sheet (printed matter) passing through the inspection unit 106, and transmits the captured image to the inspection apparatus 108 via the inspection apparatus I/F 215. Note that the CIS for the imaging unit 218 is an example of a sensor, and may be another type of sensor such as a CCD image sensor, and the imaging method is not limited.

Next, a configuration of the large-volume stacker 107 will be described.

By deploying, into a RAM 222, a program stored in a storage unit 248 to execute it, a CPU 221 manages control and calculation in each unit in the large-volume stacker 107 via a system bus 224. The RAM 222 is a type of general volatile storage device that can be directly accessed from the CPU 221, and is used as a work area of the CPU 221 and other temporary data storage areas. The storage unit 248 stores a program to be executed by the CPU 221, and further functions as a temporary storage area and a work memory during operation of the large-volume stacker 107. A sheet discharge unit 223 manages sheet discharge operation to the main tray 324 and the top tray 320 and monitoring and control of a stacking situation of each of the main tray 324 and the top tray 320.

Next, a configuration of the relay conveyance unit 115 will be described.

By deploying, into a RAM 252, a program stored in a storage unit 254 to execute it, a CPU 251 manages control and calculation in each unit of the relay conveyance unit 115 via a system bus 255. The RAM 252 is a type of general volatile storage device that can be directly accessed from the CPU 251, and is used as a work area of the CPU 251 and other temporary data storage areas. The storage unit 254 stores a program to be executed by the CPU 251, and further functions as a temporary storage area and a work memory during operation of the relay conveyance unit 115. A sheet discharge unit 253 manages the sheet discharge operation to the top tray 325 and monitoring and control of a stacking situation of the top tray 325.

Next, a configuration of the finisher 116 will be described.

By deploying, into a RAM 262, a program stored in a storage unit 264 to execute it, a CPU 261 manages control and calculation in each unit of the finisher 116 via a system bus 265. The RAM 262 is a type of general volatile storage device that can be directly accessed from the CPU 261, and is used as a work area of the CPU 261 and other temporary data storage areas. The storage unit 264 functions as a temporary storage area and a work memory during operation of the finisher 116. A post-processing unit 263 executes post-processing on the printed matter, such as binding, folding, or stapling.

Next, a configuration of the inspection apparatus 108 will be described.

By deploying, into a RAM 227, a program stored in a storage unit 228 to execute it, a CPU 226 manages control and calculation in each unit in the inspection apparatus 108 via a system bus 230. The RAM 227 is a type of general volatile storage device that can be directly accessed from the CPU 226, and is used as a work area of the CPU 226 and other temporary data storage areas. The storage unit 228 stores a program to be executed by the CPU 226, and further functions as a temporary storage area and a work memory during operation of the inspection apparatus 108. A display unit 245 is, for example, a liquid crystal display to be connected to the inspection apparatus 108, and is used to receive a user input to the inspection apparatus 108 and display a state of the inspection apparatus 108.

Next, a configuration of the information processing apparatus 109 will be described.

By deploying, into a RAM 235, a program stored in a storage unit 236 to execute it, a CPU 234 manages control and calculation in each unit in the information processing apparatus 109 via the system bus 239. The RAM 235 is a type of general volatile storage device that can be directly accessed from the CPU 234, and is used as a work area of the CPU 234 and other temporary data storage areas. The storage unit 236 stores a program to be executed by the CPU 234, and further functions as a temporary storage area and a work memory during operation of the information processing apparatus 109. An NWI/F 237 is connected to an NWI/F 240 of the client computer 110 via a network and communicates with the client computer 110. A PDL analysis unit 231 executes interpretation processing of PDL data such as PDF, PostScript, and PCL received from the client computer 110. A display unit 232 is, for example, a liquid crystal display to be connected to the information processing apparatus 109, and is used to receive a user input to the information processing apparatus 109 and display a state of the information processing apparatus 109.

Note that in the embodiment, a form in which the information processing apparatus 109 and the inspection apparatus 108 do not directly communicate with each other is described, but this form is merely an example. For example, a form may be taken in which the inspection apparatus 108 includes an NWI/F, and the information processing apparatus 109 directly communicates with the inspection apparatus 108 via the NWI/F and the NWI/F 237.

Finally, a configuration of the client computer 110 will be described.

By deploying, into a RAM 242, a program stored in a storage unit 244 to execute it, a CPU 243 manages control and calculation in each unit in the client computer 110 via a system bus 246. The RAM 242 is a type of general volatile storage device that can be directly accessed from the CPU 243, and is used as a work area of the CPU 243 and other temporary data storage areas. The storage unit 244 stores a program to be executed by the CPU 243, and further functions as a temporary storage area and a work memory during operation of the client computer 110.

FIG. 3 depicts a schematic cross-sectional view for describing an internal configuration of the printing apparatus 101 according to the embodiment and equipment to be connected to the printing apparatus 101.

The printing apparatus 101 receives a user input via the UI panel 102, and displays the state of printing and equipment. The sheet feed decks 103 and 104 can store various sheets. Each sheet feed deck can separate only the uppermost one of the stored sheets and convey it to a sheet conveyance path 305. Development stations 301 to 304 form toner images using color toners of Y, M, C, and K, respectively, in order to form a color image. The toner images formed here are subjected to primary transfer to an intermediate transfer belt 306 to form a color toner image on the intermediate transfer belt 306. The intermediate transfer belt 306 rotates clockwise in FIG. 3, and the color toner image is transferred to the sheet conveyed from the sheet conveyance path 305 at a secondary transfer position 307. A fixing unit 308 includes a pressure roller and a heating roller, and fixes the color toner image onto the sheet by melting and pressing the toner as the sheet passes through between the rollers. The sheet having passed through the fixing unit 308 is conveyed to a conveyance path 312 through a sheet conveyance path 309. In a case where further melting and pressing are required for fixing depending on the type of sheet, the sheet having passed through the fixing unit 308 is conveyed to a second fixing unit 310 via the upper sheet conveyance path, and after being subjected to additional melting and pressing, conveyed to the conveyance path 312 through a sheet conveyance path 311. In a case where the image forming mode is double-sided printing, the sheet on which fixing has been executed is conveyed to a sheet reversing path 313, reversed by the reversing path 313, and then conveyed to a double-sided conveyance path 314, and image transfer of the second surface is performed at the secondary transfer position 307.

CISs 315 and 316 are disposed to face each other in the inspection unit 106. The CIS 315 is a sensor configured to read the upper surface of the sheet, and the CIS 316 is a sensor configured to read the lower surface of the sheet. The inspection unit 106 scans the sheet using the CISs 315 and 316 at a timing when the sheet conveyed through a sheet conveyance path 317 reaches a predetermined position. The scanned image is transmitted to the inspection apparatus 108 via the inspection apparatus I/F 215 and the inspection unit I/F 229. The CPU 226 of the inspection apparatus 108 determines whether the received image has a defect, and notifies the inspection unit 106 of a determination result again via the inspection unit I/F 229 and the inspection apparatus I/F 215. The CPU 216 of the inspection unit 106 notifies the large-volume stacker 107, the relay conveyance unit 115, and the finisher 116 of the received determination result via the accessory I/Fs 214, 220, 250, and 260.

The large-volume stacker 107 has the main body 318 including the main tray 324 as a tray on which sheets are stacked and the top tray 320 disposed on the upper part of the main body 318. The sheet having passed through the inspection unit 106 enters the large-volume stacker 107 through a sheet conveyance path 319, and is stacked on the main tray 324 from the sheet conveyance path 319 via a sheet conveyance path 322. In a case of outputting the sheet to the top tray 320, the CPU 221 of the large-volume stacker 107 conveys the sheet from the sheet conveyance path 319 to the top tray 320 via a sheet conveyance path 321. A reversing unit 323 for reversing the sheet is used in a case of stacking the sheet onto the main tray 324. The reversing unit 323 reverses the sheets once when the sheets are stacked on the main tray 324 such that the orientation of the incoming sheets and the orientation of the sheets at the time of stacking are the same. On the other hand, in a case of conveying to the top tray 320, the sheet is discharged as it is without being flipped at the time of stacking, and therefore the reversing operation at the reversing unit 323 is not performed.

The relay conveyance unit 115 can discharge the sheet inspected by the inspection unit 106 to the top tray 325 via a sheet conveyance path 327. A long tray 326 can be additionally installed in the top tray 325. By installing the long tray 326, a long sheet of 1 m or more, for example, can be discharged and stacked without a stacking defect.

Specifically, the finisher 116 has finishing functions such as stapling (one-point/two-point binding), punching (two-hole/three-hole), and saddle stitching. The finisher 116 includes the two sheet discharge trays 341 and 342, and outputs sheets to the sheet discharge tray 341 via a sheet conveyance path 329. However, processing such as stapling cannot be performed in the sheet conveyance path 329. In a case where processing such as stapling is performed, a finishing function designated by the user is executed by a processing unit 343 via a sheet conveyance path 340, and a sheet is output therefrom to the sheet discharge tray 342. Each of the sheet discharge trays 341 and 342 can be lifted and lowered, and it is possible to operate so as to lower the sheet discharge tray 341 and stack, onto the sheet discharge tray 341, the sheet subjected to the finishing processing in the processing unit 343. Note that the long tray 326 can be installed in the sheet discharge tray 341. By this, similarly to the relay conveyance unit 115, the long sheet can be discharged and stacked without a stacking defect.

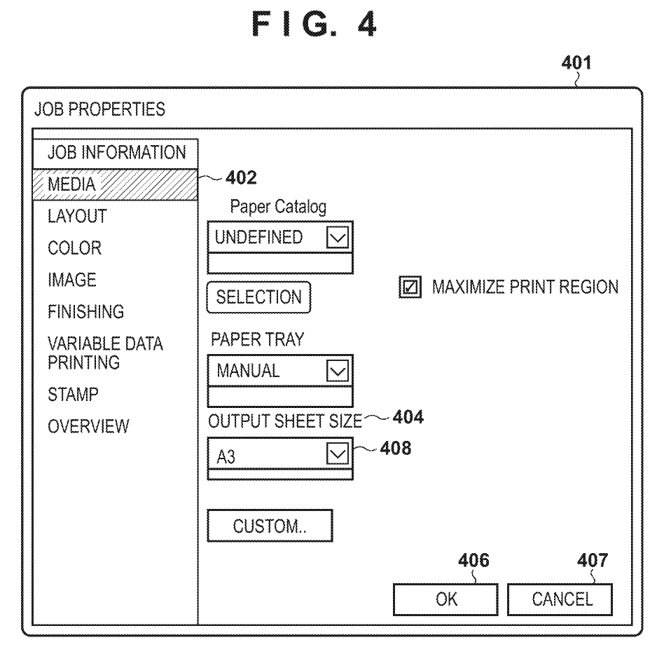

FIG. 4 depicts a view illustrating an example of a property screen 401 of a job for setting various conditions of the print job that is to be displayed on the display unit 232 of the information processing apparatus 109 during startup of the information processing apparatus 109 according to the embodiment.

The property of the job is stored as a data file in the storage unit 236 of the information processing apparatus 109, and the CPU 234 deploys it into the RAM 235 at the time of screen display or job execution. Then, the data of the RAM 235 is updated according to the setting on the property screen 401, and the data file of the storage unit 236 is also finally updated. There are many job conditions, and buttons are displayed by category on the left of the screen. On the property screen 401 of FIG. 4, a media button 402 regarding setting of a sheet to be used for printing is selected. By this, a setting screen regarding the sheet corresponding to the setting of the printing sheet stored in the RAM 235 is displayed. The sheet size to be printed is displayed on an output sheet size 404, and "A3" is selected in FIG. 4. In a case where it is desired to change the sheet size on this screen, a selection button 408 for an output sheet size is pressed. By this, a list (not illustrated) of settable sheet sizes is displayed, and the user can select and set a sheet size desired to use for printing from the list. When an OK button 406 is pressed, the setting made on this screen 401 is stored in the RAM 235, and the setting is stored in a nonvolatile memory area of the storage unit 236 as a property of the job. In a case of cancelling all the values input on this screen and not storing, the user presses a cancel button 407.

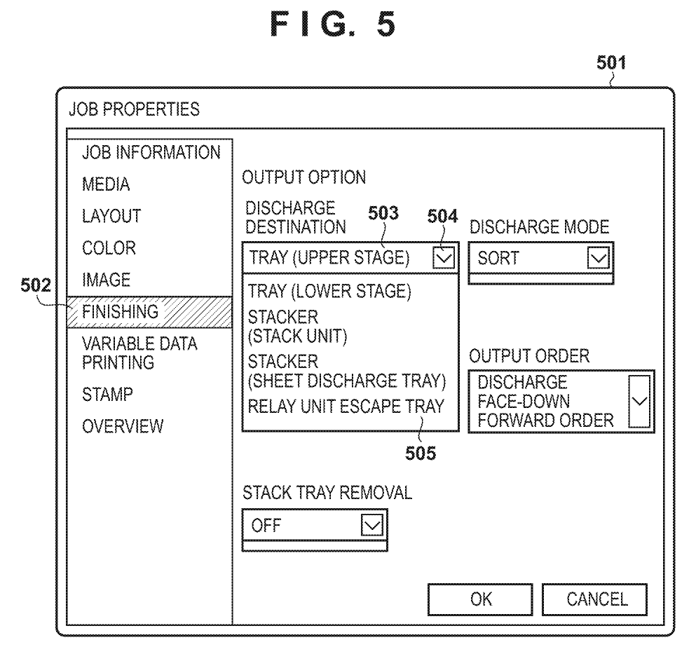

FIG. 5 depicts a view illustrating an example of a setting screen 501 of a job to be displayed on the display unit 232 of the information processing apparatus 109 during startup of the information processing apparatus 109 according to the embodiment.

In FIG. 5, a finishing button 502 at the left portion of the screen is selected, and the setting screen 501 regarding finishing at the finisher 116 is displayed.

A sheet discharge destination 503 displays a sheet discharge destination to which the printed sheet is discharged. In FIG. 5, the sheet discharge tray 341 of the finisher 116 is selected as a sheet discharge destination. Therefore, "tray (upper stage)" is displayed in the sheet discharge destination 503. Here, in a case of desiring to change the sheet discharge destination, the user presses a sheet discharge destination selection button 504 to display a sheet discharge destination selection candidate list 505, and selects a sheet discharge destination displayed in the list 505. The sheet discharge destination selection candidate list 505 displays a list of trays to which the printing apparatus 101 can discharge the printed sheet.

Next, an inspection function of the inspection apparatus 108 according to the embodiment will be described.

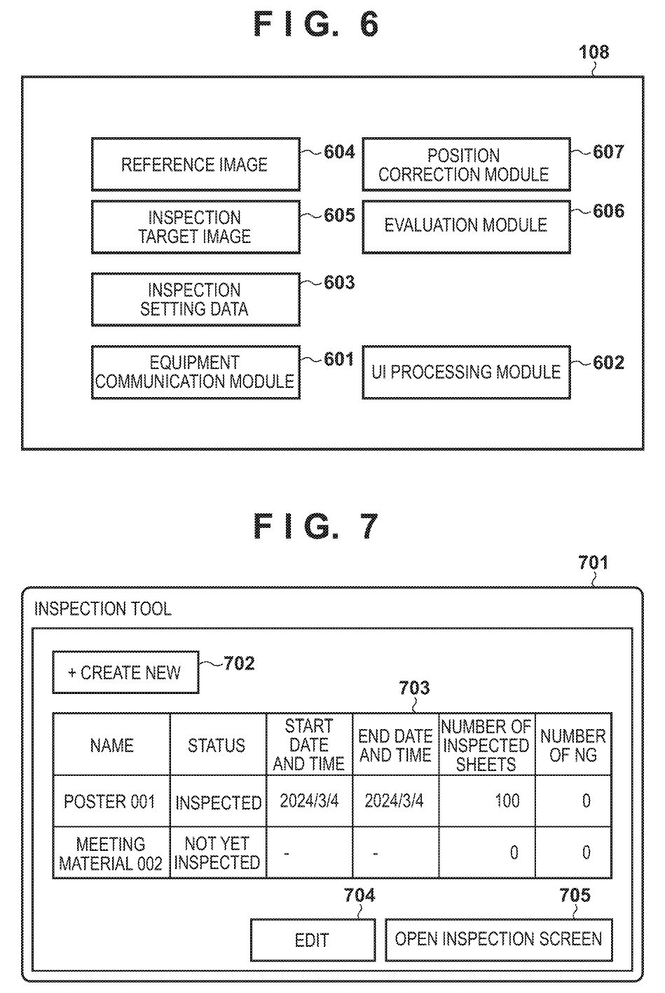

FIG. 6 is a functional block diagram for describing functions of the inspection apparatus 108 according to the embodiment.

An equipment communication module 601 communicates with the printing apparatus 101 via the inspection unit I/F 229. The imaging unit 218 equipped in the inspection unit 106 is caused to read a printed matter printed for inspection, and image data obtained by the reading is received as a read image. The equipment communication module 601 notifies the printing apparatus 101 of an inspection result of the read image, and changes the sheet discharge destination of the inspected printed matter according to the inspection result. A UI processing module 602 receives display of a state of an inspection job, input of an inspection condition from the user, and the like. Inspection setting data 603 includes values such as a threshold (corresponding to the inspection level) for determining whether the inspection passes or fails. A reference image 604 is correct image data to be used for inspection. This reference image 604 may be a reference image by obtaining a read image by reading, by the inspection unit 106, a printed matter on which a correct image is printed, or may be a reference image by receiving raster image processing (RIP) data generated by the information processing apparatus 109 and used for printing at the printing apparatus 101.

An inspection target image 605 is a read image obtained by the inspection unit 106 reading a printed matter by the imaging unit 218. The inspection setting data 603, the reference image 604, and the inspection target image 605 are stored as files in a nonvolatile memory area, which is the storage unit 228 of the inspection apparatus 108. An evaluation module 606 compares the reference image 604 with the inspection target image 605, and determines whether the image of the printed matter satisfies inspection criteria. For example, in a case where the inspection target is "contamination (spot) detection", the evaluation module 606 determines that the inspection is passed if the size of a spot that does not exist in the image of the reference image 604 and exists only in the inspection target image 605 is a threshold or less, and determines that the inspection result is fail if the size exceeds the threshold. Note that the inspection target image (read image) received from the inspection unit 106 may have tilt or displacement due to an influence of a conveyance state of the printed matter or the like. A position correction module 607 performs position correction by rotating the read image and/or moving the coordinates, and uses the corrected image data as the inspection target image 605.

Next, an operation screen of the inspection apparatus 108 will be described.

FIG. 7 depicts a view illustrating an example of a main screen 701 of an inspection tool to be displayed on the display unit 245 of the inspection apparatus 108 according to the embodiment.

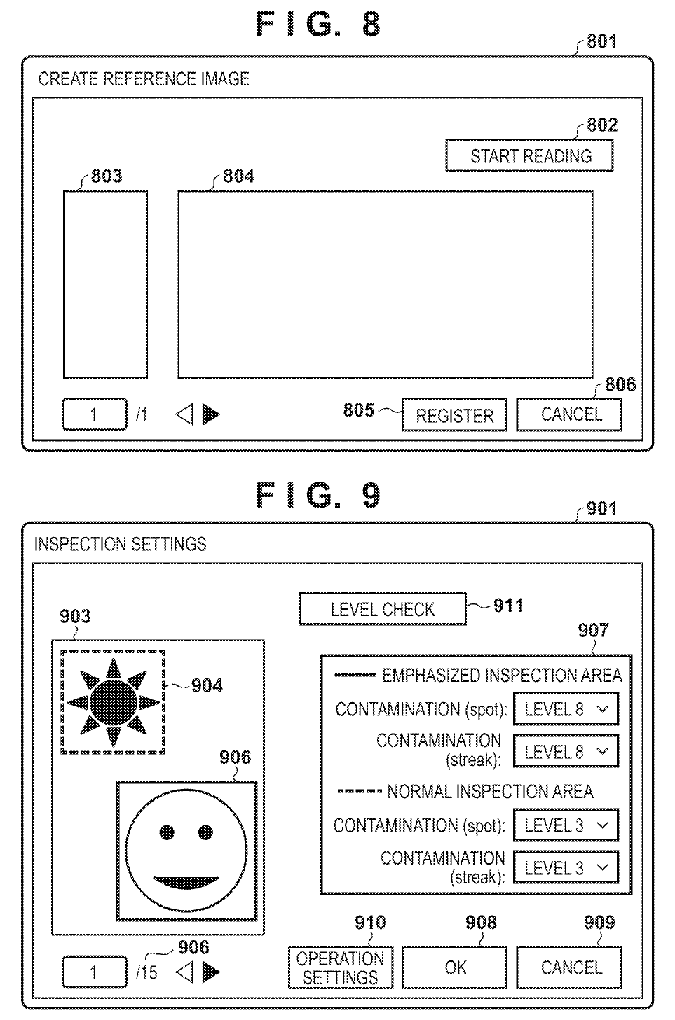

In FIG. 7, inspection data 703 having been already registered is displayed at the center of the screen. In the example of FIG. 7, inspected data named "poster 001" and uninspected inspection data named "meeting material 002" are displayed. The inspected data includes start and end dates and times of the inspection, the number of sheets (100 sheets in FIG. 7), and the number of NG sheets (the number of sheets of the printed matter determined to be failed, and 0 in FIG. 7). In a case of newly creating inspection data, the user presses a newly creating button 702. By this, the screen transitions to the screen of FIG. 8, and the user starts processing from creation of a reference image. In a case where inspection data is created by editing existing inspection data, registered inspection data is selected and an edit button 704 is pressed. In a case where inspection is executed, an "open inspection screen button" 705 is pressed.

FIG. 8 depicts a view illustrating an example of a reference image creation screen 801 to be displayed on the display unit 245 of the inspection apparatus 108 by the newly creating button 702 of FIG. 7 being pressed.

When the reference image creation screen 801 is displayed, a file for newly storing a reference image is created in the RAM 227 of the inspection apparatus 108. When a "start reading" button 802 is pressed, the inspection apparatus 108 is brought into a waiting state for reading the reference image, and a scanned image obtained by scanning, by the inspection unit 106, the sheet on which the correct image is printed is obtained as a reference image. Alternatively, the reference image may be obtained by receiving RIP data from the information processing apparatus 109. The reference image obtained in this manner is displayed in a thumbnail view 803 and a reference image display field 804. Here, in a case of registering the displayed image as a reference image, the user presses a registration button 805. After being associated with new inspection data, this reference image is stored as a file in the storage unit 228 of the inspection apparatus 108 as a reference image of the new inspection data. That is, the file includes the inspection data and the reference image corresponding thereto. Here, in a case of ending the processing without newly registering the inspection data, the user presses a cancel button 806.

FIG. 9 depicts a view illustrating an example of an inspection setting screen 901 to be displayed by the edit button 704 of FIG. 7 being pressed in the inspection apparatus 108 according to the embodiment.

When the inspection data is selected and the edit button 704 is pressed, the data file of the reference image associated with the selected inspection data is read from the storage unit 228 to the RAM 227, and the inspection setting screen 901 of FIG. 9 is displayed. The reference image is displayed in a reference image display area 903. A button 906 is used to select a reference image to be displayed in the display area 903 in a case where there are a plurality of reference images. The example of FIG. 9 illustrates a state in which the first of 15 reference images is selected. The user can designate an inspection area to be an inspection target by clicking on the displayed reference image with a pointing device. Here, it is assumed that an emphasized inspection area 905 and a normal inspection area 904 can be designated as inspection areas. For each area, for example, inspection levels of spot contamination and streak contamination can be set. An area 907 displays inspection levels of spot contamination and streak contamination set for each of the emphasized inspection area 905 and the normal inspection area 904. In this example, the inspection levels of spot contamination and streak contamination in the emphasized inspection area 905 are all set to level 8, and the inspection levels of the spot contamination and the streak contamination in the normal inspection area 904 are all set to level 3. Here, the inspection level can be set to an integer value in a range of 1 to 9. In a case where the numerical value of the inspection level is large, the inspection apparatus 108 determines that the inspection result is fail even for a small spot or a thin streak by performing the inspection more strictly. The inspection area is represented by a coordinate value, and the inspection level is stored as a number as part of the inspection data on the RAM 227. When an OK button 908 is pressed, the setting data set on this screen 901 is stored as part of the inspection data of the RAM 227, and is stored as a file in the nonvolatile memory of the storage unit 228. Here, for example, the above-described threshold corresponding to the inspection level 9 is the smallest value, and the threshold increases as the numerical value of the inspection level decreases. Therefore, in a case of the inspection level 9, if the difference between the read image and the reference image is larger than the smallest threshold, it is determined that there is a defect in the print image, and therefore the inspection level is the strictest one.

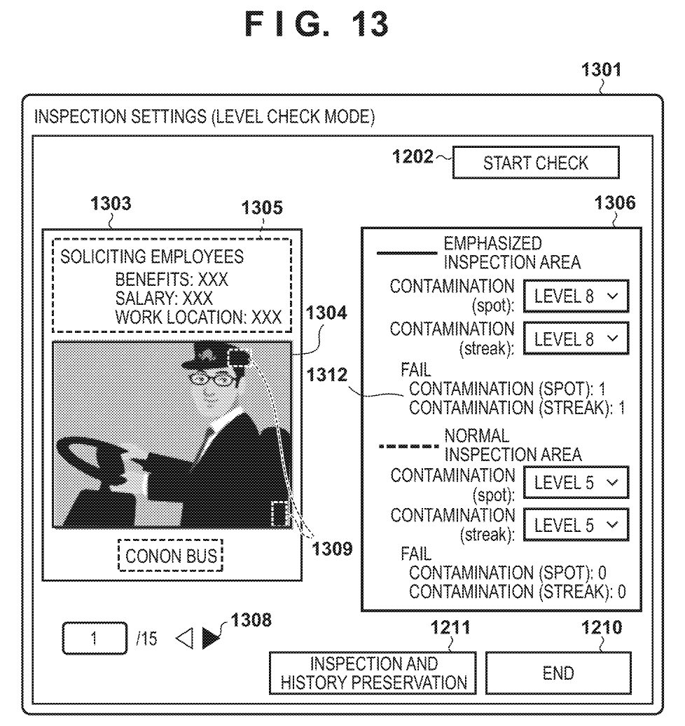

When a level check button 911 is pressed, the screen transitions to a level check mode screen on which the inspection result at the inspection level selected for the inspection area can be confirmed. The level check mode screen will be described later with reference to FIG. 13. An operation setting button 910 allows viewing and changing setting values regarding the operation of the inspection apparatus 108 at the time of inspection execution. These setting values are part of the inspection data and have already been read into the RAM 227.

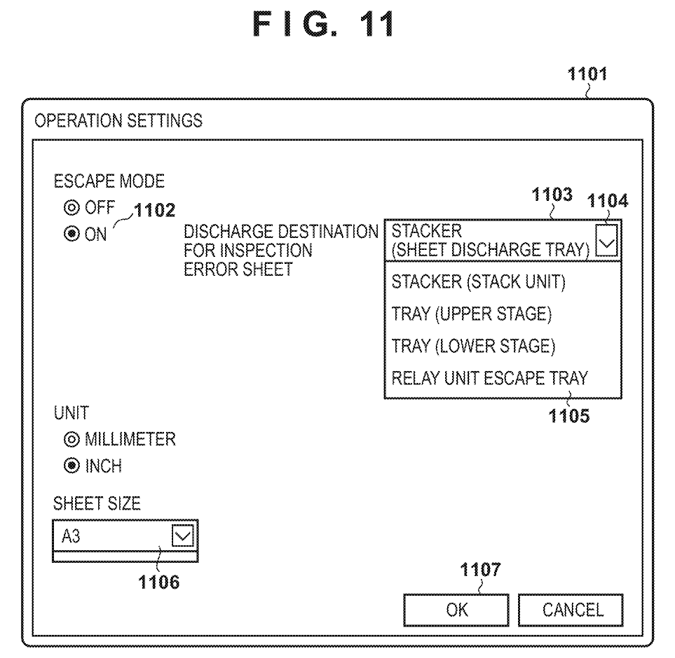

FIG. 11 depicts a view illustrating an example of an operation setting screen 1101 to be displayed on the inspection apparatus 108 when the operation setting button 910 of FIG. 9 is pressed.

The operation setting screen 1101 enables setting information regarding the inspection operation to be changed and confirmed. An escape mode is a mode for separating a sheet that has failed the inspection from a sheet that has passed the inspection. When an escape mode switch 1102 is selected to be on, the sheet that has passed the inspection and the sheet that has failed can be output separately to designated sheet discharge destinations. In a case where the escape mode switch 1102 is off, the failed sheet is output to the same sheet discharge destination as that of the passed sheet. An inspection error (inspection failed) sheet discharge destination display unit 1103 displays a tray to which a sheet determined to be failed in the inspection is discharged. In the example of FIG. 11, when the escape mode is on, the top tray 320 of the large-volume stacker 107 is selected as a sheet discharge destination of the failed sheet. Here, in a case of changing the sheet discharge destination, the user presses a sheet discharge destination change button 1104 to display a sheet discharge destination selection candidate list 1105 for the inspection error sheet, and selects a desired sheet discharge destination from the selection candidate list 1105.

A sheet size 1106 is the sheet size of the reference image to be a comparison target of the inspection, and an "A3" size is selected in FIG. 11. When an OK button 1107 is pressed, the various setting values set on this screen 1101 are sequentially overwritten on the inspection data of the RAM 227 of the inspection apparatus 108. Then, the data stored in the RAM 227 is stored as a file in the nonvolatile memory of the storage unit 228.

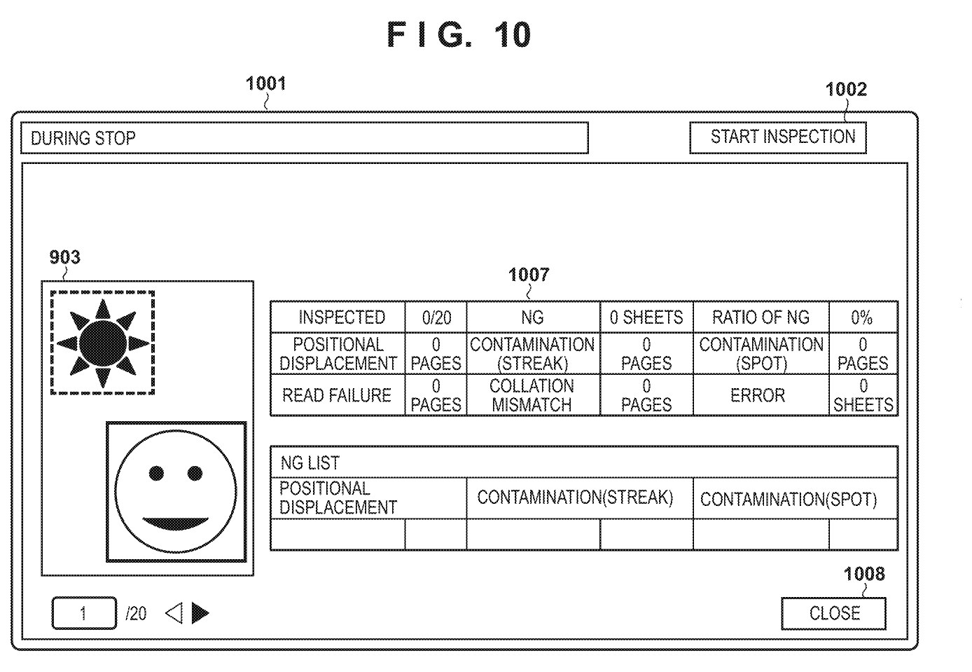

FIG. 10 depicts a view illustrating an example of an inspection screen 1001 to be displayed on the display unit 245 of the inspection apparatus 108 according to the embodiment.

FIG. 10 illustrates a state before the inspection is started. Here, when a start inspection button 1002 is pressed, the inspection apparatus 108 is brought into an inspection state, and comparison inspection between the reference image 903 and a read image obtained by reading the printed matter is performed. A result display field 1007 displays the number of inspected pages and the number of detected failures. Here, the inspection is not started, and thus the number of inspected sheets, the number of NG sheets, and the like are all 0. A close button 1008 is a button for closing this screen and transitioning to the previous screen.

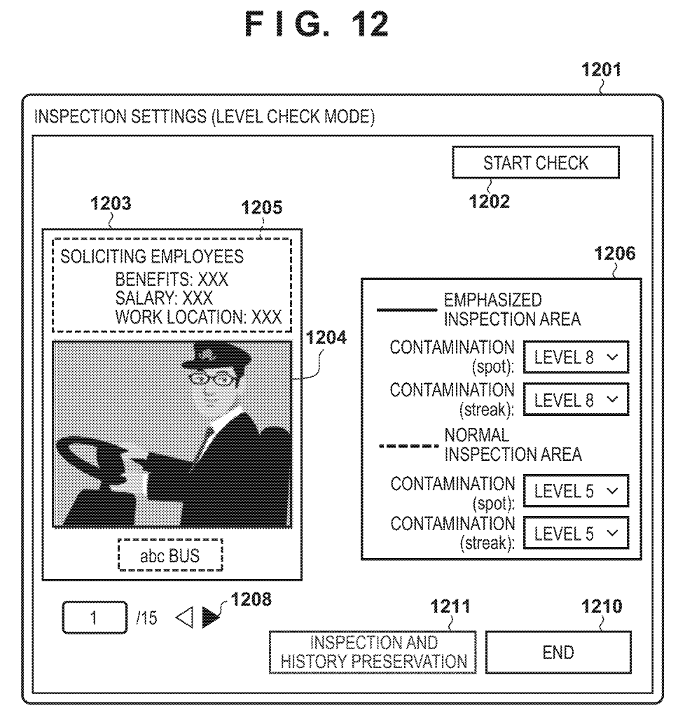

FIG. 12 depicts a view illustrating an example of a level check mode screen 1201 to be displayed when the level check button 911 of the inspection setting screen 901 of FIG. 9 is pressed, to be displayed on the display unit 245 of the inspection apparatus 108 according to the embodiment.

A display area 1203 of the reference image displays a reference image registered in the inspection apparatus 108 prior to the inspection as a reference image of the inspection. A page feed button 1208 is a button for switching the page of the reference image. The user designates an emphasized inspection area 1204 and a normal inspection area 1205 on the reference image, and the emphasized inspection area 1204 is indicated by a solid line frame and the normal inspection area 1205 is indicated by a broken line frame. An area 1206 displays the inspection levels of spot contamination and streak contamination set for each of the emphasized inspection area 1204 and the normal inspection area 1205. These inspection levels can be changed in the inspection levels 1 to 9 similarly to the area 907 of FIG. 12. Here, level 5 is set as the inspection level of the normal inspection area 1205, and level 8 is set as the inspection level of the emphasized inspection area 1204. When an end button 1210 is pressed, the level check mode is ended, and the screen returns to the inspection setting screen 901 of FIG. 9. On this screen, a check start button 1202 is enabled, and when the check start button 1202 is pressed, reading of the printed matter to be an inspection target is started in order to confirm the inspection result based on the inspection level set on this screen. Note that in a case where the reference image is an RIP image, when a job is registered in the information processing apparatus 109, the inspection apparatus 108 may obtain, from the information processing apparatus 109, as a reference image, image data of the job stored together therewith to store it.

Note that in a case where a plurality of printed matters are generated and inspected at this time, reference images corresponding to the plurality of printed matters are also registered in advance, and are stored in the storage unit 228 of the inspection apparatus 108 in association with those read images together with the read images of the plurality of printed matters.

FIG. 13 depicts a view illustrating an example of an operation screen 1301 in the level check mode (confirmation mode) to be displayed on the display unit 245 of the inspection apparatus 108 according to the embodiment. In this screen, the check start button 1202 is disabled.

An image of the printed matter is read by the inspection unit 106, and a state in which the comparison inspection between the read image and the reference image is performed is displayed on the display unit 245. A display area 1303 displays a read image unlike the display area 1203 of FIG. 12. A page feed button 1308 is a button for feeding the page of read images when a plurality of read images are stored as an inspection target. Then, the display area 1303 displays a comparison result between the reference image and the read image based on the inspection level designated by the user. In the example of FIG. 13, there is no defect portion determined to be failed in a normal inspection area 1305 of the read image. On the other hand, an emphasized inspection area 1304 of the read image identifiably displays two failed areas (defect portions) 1309 determined to have a predetermined difference (corresponding to the inspection level) between the read image and the reference image. Specifically, in this inspection, for example, the read image and the reference image may be compared for each pixel, and a pixel area in which a ratio of pixels whose difference is determined to be larger than a predetermined difference (corresponding to the inspection level) is larger than a predetermined value (may be set corresponding to the inspection level) may be determined as a defect portion.

An area 1306 displays the inspection levels of spot contamination and streak contamination and a failed result display unit 1312 set for each of the emphasized inspection area 1204 and the normal inspection area 1205. The failed result display unit 1312 displays that one portion of contamination (spot) and one portion of contamination (streak) are detected in the failed areas. The inspection level displayed in this area 1306 can be changed in the inspection levels 1 to 9 similarly to the case of the area 1206 of FIG. 12.

Here, for example, in a case of viewing the read image displayed in the display area 1303 and considering this detection result is over detection, the user changes the inspection level of the emphasized inspection area 1304 to be lower. Then, after changing the inspection level, the user presses an "inspection and history preservation" button 1211, thereby instructing comparison between the reference image and the read image. By this, the display area 1303 displays a detection result based on the inspection level after the change. This enables the user to confirm the difference in the inspection result corresponding to the change in the inspection level without performing reprinting for generating the printed matter again. Here, for example, it is assumed that the inspection level of the emphasized inspection area 1304 is changed from level 8 to level 7 to perform reinspection.

Note that although not illustrated in FIG. 13, comparison inspection between the read image and the reference image may be executed based on each of the inspection levels 1 to 9, for example, and the failed portion and the number thereof in each of the inspection levels 1 to 9 may be stored. The inspection result of each inspection target area may be displayed in correspondence with the inspection level.

For each of the inspection levels 1 to 9, only the inspection level at which it is determined that there is a failed portion may be displayed in association with, for example, the inspection target area.

In a case where there is a failed portion, an inspection level at which the portion is switched from passing to failing or from failing to passing may be displayed.

The inspection results of areas corresponding to a plurality of inspection levels may be displayed side by side for each area so that the inspection results can be recognized.

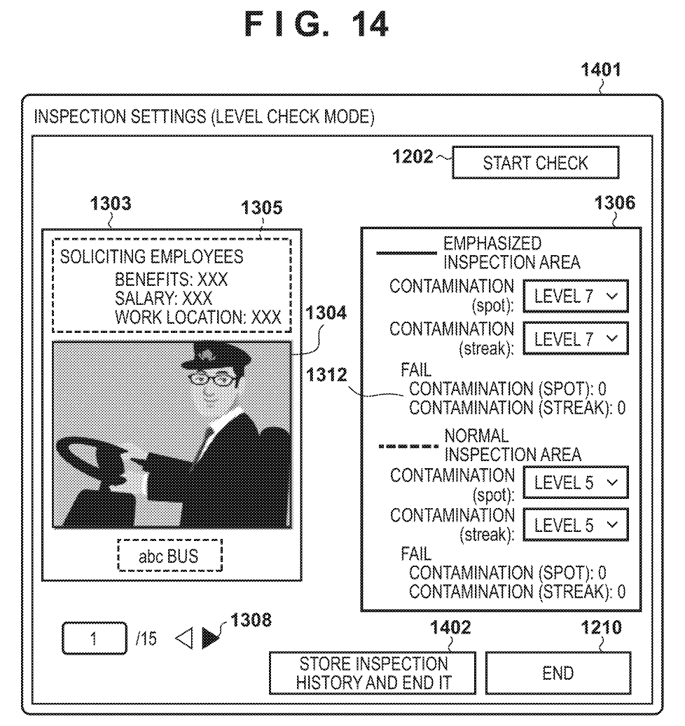

FIG. 14 depicts a view illustrating an example of an operation screen 1401 of the level check mode when the inspection level of the emphasized inspection area 1304 is changed from level 8 to level 7 and the reinspection is performed. In this screen, the check start button 1202 is also disabled.

Here, comparison between the reference image and the inspection target image is executed based on the inspection level that has been changed, and the inspection result is displayed. In the display area 1303, there is no longer the failed area 1309, which is regarded as over detection displayed in FIG. 13. The failed result display unit 1312 displays that the contamination (spot) and the contamination (streak) are no longer present. This enables the user to determine that there is no longer a portion determined to be a defect if the inspection level of the emphasized inspection area 1304 is 7, and there is no problem even in the image of the emphasized inspection area 1304 in the read image from the read image (inspection target image) displayed in the display area 1303. That is, it is possible to determine that over detection can be prevented by lowering the inspection level to 7 whereas over detection occurs due to inspection stricter than necessary at the inspection level 8. When the optimum inspection level can be confirmed in this manner, the end button 1210 is pressed, and the inspection level of the emphasized inspection area of the inspection setting data 603 can be updated and stored.

When a "store inspection history and end" button 1402 is pressed, the inspection target image 605 already stored in the inspection apparatus 108 is compared with the reference image 604 based on the updated inspection level. Then, as described with reference to FIG. 7, the inspection data and the inspection result thereof can be added as an inspection history. In this manner, the user can obtain the inspection result based on the updated inspection level to record it as an inspection history without performing printing for generating the printed matter and reading the printed matter again. This enables the user to know which sheet has been failed based on the inspection history, and to instruct removal or reprinting of the printed matter determined to be failed.

Next, processing when the level check mode is started in the inspection apparatus 108 according to the embodiment will be described.

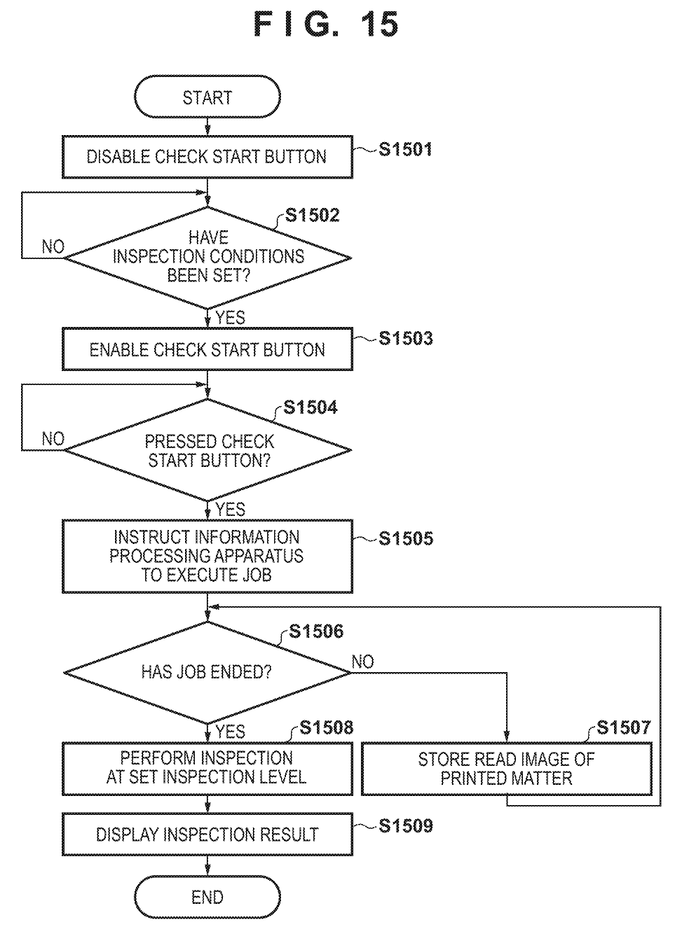

FIG. 15 is a flowchart for describing processing when the inspection apparatus 108 according to the embodiment executes the level check mode. Note that the processing shown in this flowchart is implemented by the CPU 226 of the inspection apparatus 108 deploying, into the RAM 227, a program stored in the storage unit 228 to execute it. The processing shown in this flowchart is started in a state where the level check button 911 of FIG. 9 is pressed to display the level check mode screen of FIG. 12. The inspection data selected by the user at this time and the reference image corresponding thereto are read from the storage unit 228 to the RAM 227, and the reference image display area 1203 displays the reference image.

First, in step S1501, the CPU 226 disables the check start button 1202. This is because there is a case where setting of the inspection area and the like are not completed. Next, the processing proceeds to step S1502, and the CPU 226 waits for the user to set the inspection conditions such as the inspection area and the inspection level in the reference image. The setting processing of the inspection conditions such as the inspection area is as described above with reference to FIG. 9. The determination as to whether the setting has been made in step S1502 may be made based on, for example, whether the OK button 908 of FIG. 9 has been pressed. Upon determining that the inspection condition is set in this manner, the processing proceeds to step S1503, and the CPU 226 enables the check start button 1202. Then, in step S1504, the CPU 226 waits until the check start button 1202 is pressed, that is, the start of check is instructed.

Upon detecting in step S1504 that the check start button 1202 is pressed and the start of inspection is instructed, the processing proceeds to step S1505 and the CPU 226 instructs the information processing apparatus 109 to start the print job. Then, the processing proceeds to step S1506, while waiting for the job executed by the information processing apparatus 109 to end, the CPU 226 stores, into the RAM 227, in step S1507 the read image of the printed matter of each page received from the inspection unit 106. When the job is ended in this manner, the read images of all the pages are received and stored in the RAM 227, the read images are also stored as files in the storage unit 228 so that they can be used again.

Upon determining in step S1506 that the job executed by the information processing apparatus 109 has ended, the processing proceeds to step S1508, and the CPU 226 compares the reference image with the read image based on the currently set inspection level to inspect the read image. Then, the processing proceeds to step S1509, and the CPU 226 displays the inspection result onto the display unit 245 to end this processing. FIG. 13 illustrates a display example of the inspection result at this time.

Next, updating processing of an inspection result by changing the inspection level in the level check mode by the inspection apparatus 108 according to the embodiment will be described.

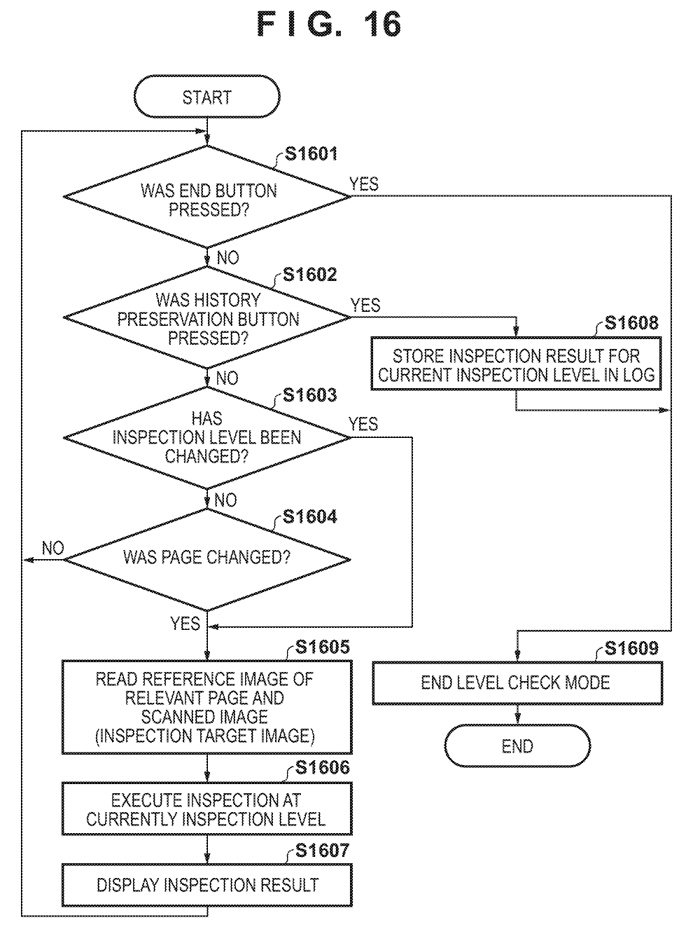

FIG. 16 is a flowchart for describing processing in which the inspection apparatus 108 according to the embodiment executes reinspection at the changed inspection level to display the result thereof after the inspection level is changed. Note that the processing shown in this flowchart is implemented by the CPU 226 of the inspection apparatus 108 deploying, into the RAM 227, a program stored in the storage unit 228 to execute it. The processing shown in this flowchart is started in a state where the processing at the time of start of the level check mode described in FIG. 15 is completed and the screen of FIG. 13 is displayed. It is assumed that the read image selected by the user at this time and the reference image corresponding thereto have been read from the storage unit 228 to the RAM 227.

First, in step S1601, the CPU 226 determines whether pressing of the end button 1210 has been detected, and upon detecting the pressing of the end button 1210, the processing proceeds to step S1609, and ends the level check mode to end this processing. Upon not detecting the pressing of the end button 1210, the processing proceeds to step S1602, and the CPU 226 determines whether the "inspection and history preservation" button 1211 has been pressed. Upon determining that the "inspection and history preservation" button 1211 has been pressed, the processing proceeds to step S1608, and the CPU 226 performs inspection of the read image using the reference image and the read image already read in the RAM 227 based on the currently set inspection level stored in the RAM 227. Then, upon ending the inspection, the CPU 226 adds the inspection result to a history file stored in the storage unit 228, and the processing proceeds to step S1609.

When the "inspection and history preservation" button 1211 has not been pressed, the processing proceeds to step S1603, and the CPU 226 determines whether the inspection level has been changed. Here, for example, the CPU 226 determines whether the inspection level of the area 1306 of FIG. 13 has been changed. Upon determining that the inspection level has been changed, the processing proceeds to step S1605, and otherwise, the processing proceeds to step S1604. In step S1604, the CPU 226 determines whether the page to be displayed, that is, the page feed button 1308 is operated to change the image of the inspection target. Here, upon determining that the display page has been changed, the processing proceeds to step S1605, and otherwise, the processing proceeds to step S1601.

In step S1605, the CPU 226 reads the reference image and the read image corresponding to the selected page having already been read in the RAM 227. Then, the processing proceeds to step S1606, and the CPU 226 functions as the evaluation module 606, and compares the reference image with the inspection target image based on the set inspection level to execute the inspection. Then, the processing proceeds to step S1607, and the CPU 226 functions as the UI processing module 602, draws the inspection target image in the display area 1303, and if there is a portion determined to be failed on the inspection target image, draws a frame indicating the portion with a broken line. Furthermore, the number of defects (spots, streaks, and the like) that have failed is displayed on the failed result display unit 1312. In this manner, the CPU 226 repeats a series of processing from step S1601 until detecting an end instruction from the user.

As described above, according to the embodiment, it is possible to easily confirm the influence of the inspection level in inspection of a read image. It is possible to set an inspection level for each inspection area of the read image, and easily confirm a difference in an inspection result depending on the inspection level for each area. As a result, there is an effect of reducing a user operation time and effort for setting the inspection level to enable the user to set a desired inspection level.

Note that in the above embodiment, inspection of the printed matter is performed by the inspection apparatus 108 and the inspection unit 106, but it may be implemented by a single inspection apparatus having these functions.

### Other Embodiments

Embodiments of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to Japanese Patent Application No. 2025-010640, which was filed on January 24, 2025 and which is hereby incorporated by reference herein in its entirety.

What is claimed is:

1. An inspection system comprising: an image forming apparatus; an inspection apparatus that inspects a printed matter formed by the image forming apparatus; and one or more controllers including one or more processors and one or more memories, wherein the one or more controllers configured to:
read the printed matter to generate an inspection target image;
set an inspection condition;
compare the inspection target image with a reference image and generate an inspection result of the inspection target image based on the inspection condition;
cause a display to display the inspection result; and
execute a confirmation mode that is able to change an inspection level included in the inspection condition and that causes a user to confirm an inspection result of the inspection target image corresponding to the changed inspection level.

2. The inspection system according to claim 1, wherein upon execution of the confirmation mode, the one or more controllers store the inspection target image, receive a change of the inspection level by a user, and cause the display to display an inspection result of an inspection target image of a stored target and the reference image based on the inspection level that has been changed.

3. The inspection system according to claim 2, wherein upon execution of the confirmation mode, the one or more controllers further store, as an inspection history, an inspection result of the inspection target image and the reference image based on the inspection level that has been changed.

4. The inspection system according to claim 3, wherein upon execution of the confirmation mode, in a case where a plurality of inspection target images are stored, the one or more controllers store, as an inspection history, an inspection result of each of the plurality of inspection target images and a corresponding reference image based on the inspection level that has been changed.

5. The inspection system according to claim 1, wherein the inspection condition includes an area to be an inspection target in the reference image and an inspection level corresponding to the area.

6. The inspection system according to claim 2, wherein upon displaying of the inspection result, the one or more controllers identifiably display an area of the inspection target image determined to be a defect in the inspection result.

7. The inspection system according to claim 6, wherein upon displaying of the inspection result, the one or more controllers display an area of the inspection target image determined to be a defect in the inspection result and an inspection level corresponding to the area.

8. The inspection system according to claim 2, wherein upon displaying of the inspection result, the one or more controllers further display a number of portions determined to be a defect in the inspection result.

9. The inspection system according to claim 1, wherein in setting the inspection condition, the one or more controllers cause the display to display a setting screen for setting the inspection condition, and receive an inspection target area in the reference image and an inspection level for the inspection target area via the setting screen.

10. The inspection system according to claim 1, wherein in setting the inspection condition, the one or more controllers cause the display to display a setting screen for setting the inspection condition, and execute the confirmation mode by pressing a predetermined button included in the setting screen.

11. The inspection system according to claim 1, wherein the one or more controllers further register a reference image corresponding to the inspection target image.

12. An inspection apparatus that inspects a printed matter formed by an image forming apparatus, the inspection apparatus comprising:
one or more controllers including one or more processors and one or more memories, wherein the one or more controllers are configured to:
read the printed matter to generate an inspection target image;
set an inspection condition;
compare the inspection target image with a reference image and generate an inspection result of the inspection target image based on the inspection condition;
cause a display to display an inspection result of the inspection target image; and
execute a confirmation mode that is able to change an inspection level included in the inspection condition and that causes a user to confirm an inspection result corresponding to the changed inspection level.

13. The inspection apparatus according to claim 12, wherein upon execution of the confirmation mode, the one or more controllers store the inspection target image, receive a change in the inspection level by a user, and cause the display to display an inspection result of the stored inspection target image and the reference image based on the inspection level that has been changed.

14. The inspection apparatus according to claim 13, wherein upon execution of the confirmation mode, the one or more controllers further store, as an inspection history, an inspection result of the inspection target image and the reference image based on the inspection level that has been changed.

15. The inspection apparatus according to claim 14, wherein in a case where a plurality of inspection target images are stored, upon execution of the confirmation mode, the one or more controllers store, as an inspection history, an inspection result of each of the plurality of inspection target images and a corresponding reference image based on the inspection level that has been changed.

16. The inspection apparatus according to claim 12, wherein the inspection condition includes an area to be an inspection target in the reference image and an inspection level corresponding to the area.

17. The inspection apparatus according to claim 13, wherein upon displaying of the inspection result, the one or more controllers identifiably display an area of the inspection target image determined to be a defect in the inspection result.

18. The inspection apparatus according to claim 17, wherein upon displaying of the inspection result, the one or more controllers display of an area of the inspection target image determined to be a defect in the inspection result and an inspection level corresponding to the area.

19. A method of controlling an inspection apparatus that inspects a printed matter formed by an image forming apparatus, the method comprising:
reading the printed matter to generate an inspection target image;
setting an inspection condition;
comparing the inspection target image with a reference image and generating an inspection result of the inspection target image based on the inspection condition;
causing a display to display an inspection result by the inspecting; and
executing a confirmation mode that is able to change an inspection level included in the inspection condition and that causes a user to confirm an inspection result by the inspecting corresponding to the changed inspection level.

20. A non-transitory computer-readable storage medium storing a program for causing a processor to execute a method of controlling an inspection apparatus that inspects a printed matter formed by an image forming apparatus, the method comprising:
reading the printed matter to generate an inspection target image;
setting an inspection condition;
comparing the inspection target image with a reference image and generating an inspection result of the inspection target image based on the inspection condition;
causing a display to display an inspection result by the inspecting; and
executing a confirmation mode that is able to change an inspection level included in the inspection condition and that causes a user to confirm an inspection result by the inspecting corresponding to the changed inspection level.
